(19) United States
(12) Patent Application Publication
(10) Pub. No.: US 2013/0025945 A1
(43) Pub. Date: Jan. 31, 2013

(54) SERVER CONTAINER WITH PAYLOAD DETECTING FUNCTION

(71) Applicants: JIN-LIANG XIONG, Shenzhen City (CN); HAI-QING ZHOU, Shenzhen City (CN); YI-XIN TU, Shenzhen City (CN)

(72) Inventors: JIN-LIANG XIONG, Shenzhen City (CN); HAI-QING ZHOU, Shenzhen City (CN); YI-XIN TU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/330,707

(22) Filed: Dec. 20, 2011

(30) Foreign Application Priority Data
Jul. 26, 2011 (CN) 201110210494.2

(51) Int. Cl. G01G 23/36

(52) U.S. Cl. 177/45

(57) ABSTRACT

A server container includes a main body, at least one support plate, at least one angle detecting module, and an alarm module. The main body includes two opposite sidewalls. Two opposite edges of each support plate is interconnected the two sidewalls. Each angle detecting module includes an angle sensor and a controlling module. The angle sensor is correspondingly positioned on one support plate and for detecting a bending angle of the support plate and generating an angle signal corresponding to the bending angle. The controlling module is configured for comparing the voltage of the angle signal with a reference voltage which corresponds to a predetermined degree and generating a control signal upon a condition that the voltage of the angle signal is greater than the reference voltage. The alarm module is configured for generating an alarm upon a condition of receiving the control signal.

### BACKGROUND

1. Technical Field

The present disclosure relates to server containers, and particularly to a server container with a payload detecting function.

2. Description of Related Art

Server containers are used for accommodating a number of blade servers, but the load-carrying capacity of a server container is limited. When the weight of the blade servers exceeds the load-carrying capacity of the server container, the server container is at risk of being damaged.

Therefore, it is desirable to provide a server container, which can overcome the limitations described.

### BRIEF DESCRIPTION OF THE DRAWINGS

FIG. 1 is an isometric view of a server container in accordance with an exemplary embodiment.

FIG. 2 is a functional block diagram of an angle detecting module of the server container of FIG. 1.

FIG. 3 is a circuit diagram of the angle detecting module of FIG. 2.

### DETAILED DESCRIPTION

Embodiments of the disclosure will be described in detail, with reference to the accompanying drawings.

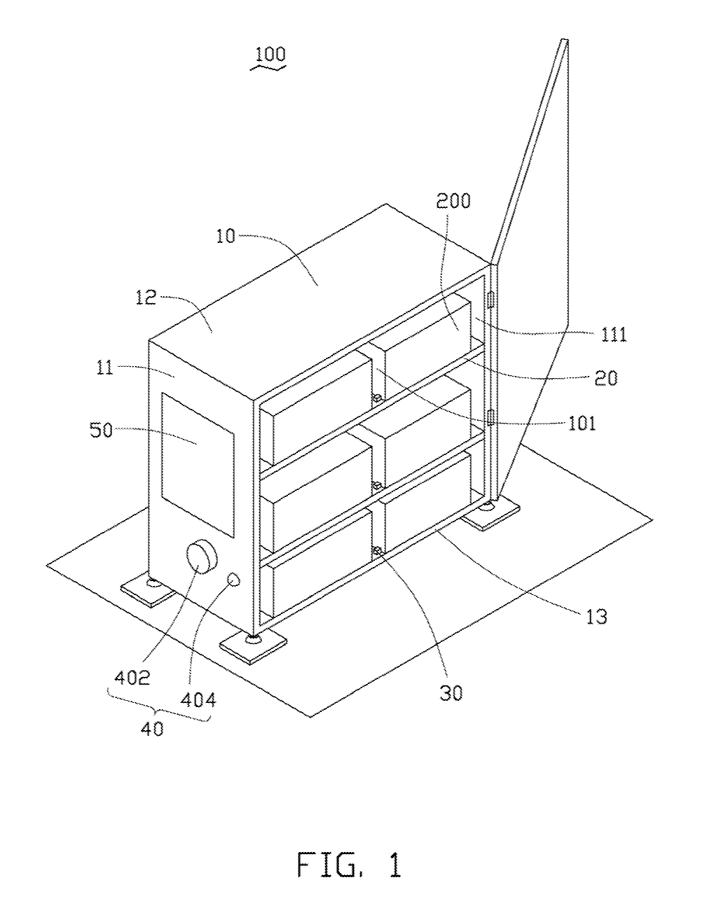

Referring to FIG. 1, a server container 100, according to an exemplary embodiment, is used for accommodating a number of blade servers 200. The server container 100 includes a main body 10, at least one support plate 20, at least one angle detecting module 30, a warning unit 40, and a display 50.

The main body 10 is cuboid and includes two sidewalls 11, an upper plate 12, and a lower plate 13. The two sidewalls 11 perpendicularly connect the upper plate 12 and the lower plate 13. Each of the sidewalls 11 includes an inner surface 111. In this embodiment, in order to enhance the strength of the main body 10, the main body 10 is made of steel or other rigid material.

The at least one support plate 20 is flat and is made of ductile materials. Two opposite edges of each support plate 20 are firmly attached to the inner surfaces 111 of the sidewalls 11. The interior of the main body 10 is divided into at least two receiving rooms 101 by the at least one support plate 20. The blade servers 200 are supported on the support plate 20. The at least one support plate 20 is at risk of being broken when a carried weight exceeds a particular payload and causes bending beyond a certain predetermined degree. In this embodiment, when there is no blade server 200 supported on the support plate 20, the support plate 20 is set parallel with a horizontal plane.

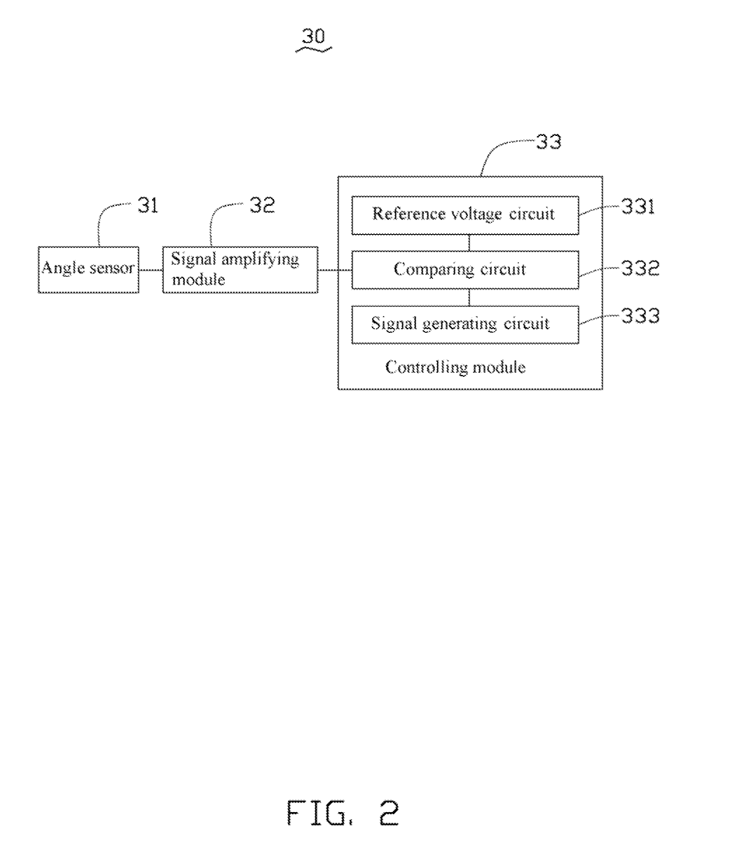

Referring also to FIG. 2, the at least one angle detecting module 30 is configured for detecting any bending angle of the at least one support plate 20. Each of the at least one angle detecting module 30 includes an angle sensor 31, a signal amplifying module 32, and a controlling module 33.

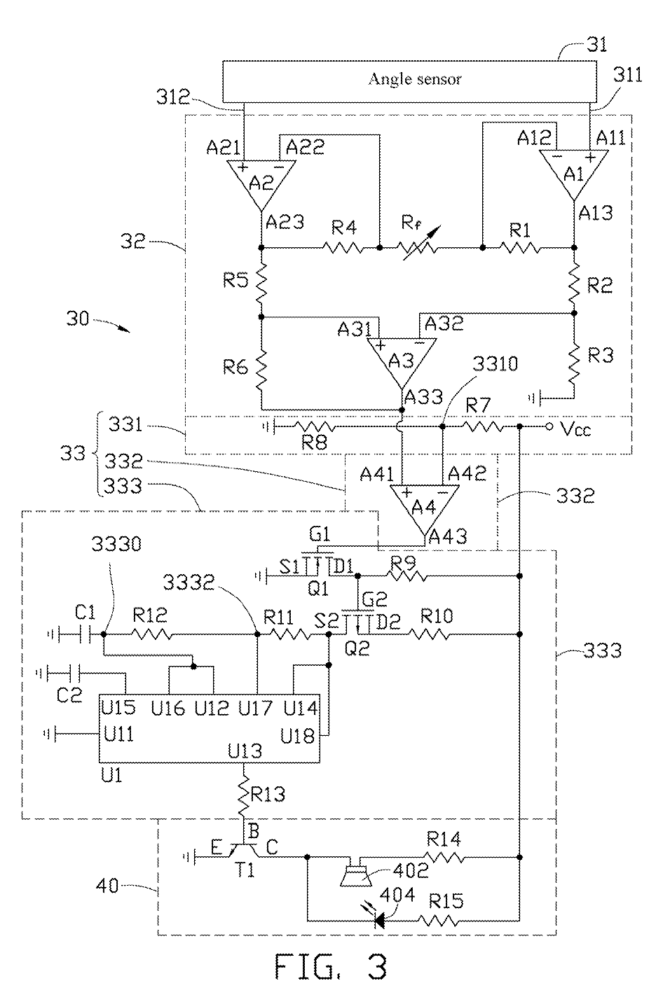

Each angle sensor 31 is correspondingly installed to one support plate 20, generally at center of the support plate 20. Each angle sensor 31 includes a first terminal 311 and a second terminal 312 (shown in FIG. 3). The value of the bending angle is detected by the angle sensor 31, and is converted to an angle signal. The angle signal is output from the first terminal 311 and the second terminal 312. The signal amplifying module 32 is connected between the angle sensor 31 and the controlling module 33 and amplifies the angle signal output from the angle sensor 31 into a detectable voltage level. The controlling module 32 presets a reference voltage V_{ref} and compares the voltage level of the amplified angle signal with the reference voltage V_{ref}. When the value of the voltage of the amplified angle signal is greater than that of the reference voltage V_{ref}, the controlling module 33 outputs a control signal to the warning unit 40. In this embodiment, the reference voltage V_{ref} corresponds to a predetermined degree, such as 15 degrees, of the support plate 20. The at least one angle sensor 31 can be chosen from SANG or KT or the like.

Referring also to FIG. 3, the signal amplifying module 32 includes a first amplifier A1, a second amplifier A2, a third amplifier A3, a sliding rheostat R_{f}, and first, second, third, fourth, fifth, and sixth resistors R1, R2, R3, R4, R5, R6. The first amplifier A1 includes a first positive input terminal A11, a first negative input terminal A12, and a first output terminal A13. The second amplifier A2 includes a second positive input terminal A21, a second negative input terminal A22, and a second output terminal A23. The third amplifier A3 includes a third positive input terminal A31, a third negative input terminal A32, and a third output terminal A33. The first positive input terminal A11 is connected to the first terminal 311 of the angle sensor 31. The second positive input terminal A21 is connected to the second terminal 312 of the angle sensor 31. The sliding rheostat R_{f} is connected between the first negative input terminal A12 and the second negative input terminal A22. The first resistor R1 is connected between the first negative input terminal A12 and the first output terminal A13. The second resistor R2 is connected between the first output terminal A13 and the third negative input terminal A32. One terminal of the third resistor R3 is connected to the third negative terminal A32, and the other terminal of the third resistor R3 is grounded. The fourth resistor R4 is connected between the second output terminal A23 and the second negative input terminal A22. The fifth resistor R5 is connected between the second output terminal A23 and the third positive input terminal A31. The sixth resistor R6 is connected between the third positive input terminal A31 and the third output terminal A33.

The controlling module 33 includes a reference voltage circuit 331, a comparing circuit 332, and a signal generating circuit 333. The comparing circuit 332 is interconnected the reference voltage circuit 331 and the signal generating circuit 333. The reference module 331 includes a seventh resistor R7 and an eighth resistor R8. The seventh resistor R7 is connected between one terminal of the eighth resistor R8 and a power source V_{cc}. The other terminal of the eighth resistor R8 is grounded. A reference voltage terminal 3310 is connected between the seventh resistor R7 and the eighth R8. The reference voltage V_{ref} is output from the reference voltage terminal 3310.

The comparing circuit 332 includes a comparator A4. The comparator A4 includes a fourth positive input terminal A41, a fourth negative input terminal A42, and a fourth output terminal A43. The fourth positive input terminal A41 is connected to the third output terminal A33, and the fourth negative input terminal A42 is connected to the reference voltage terminal 3310.

The signal generating circuit 333 includes a first transistor Q1, a second transistor Q2, a 555 trigger U1, a first capacitor C1, a second capacitor C2, and ninth, tenth, eleventh, twelfth, and thirteenth resistors R9, R10, R11, R12, R13. The first transistor Q1 is an N-channel MOSFET, and includes a first source S1, a first gate G1, and a first drain D1. The first gate G1 is connected to the fourth output terminal A43. The first source S1 is grounded. The first drain D1 is connected to the power source V_{cc} via the ninth resistor R9. The second transistor Q2 is a P-channel MOSFET, and includes a second source S2, a second gate G2, and a second drain D2. The second gate G2 is connected to the first drain D1. The second drain D2 is connected to the power source V_{cc} via the tenth resistor R10. The eleventh resistor R11 and the twelfth resistor R12 are serially connected between the second source S2 and one terminal of the first capacitor C1. The other terminal of the first capacitor C1 is grounded. The 555 trigger U1 includes a ground terminal U11, a trigger terminal U12, an output terminal U13, a reset terminal U14, a control terminal U15, a critical terminal U16, a discharge terminal U17, and a power terminal U18. The ground terminal U11 is grounded. The trigger terminal U12 and the critical terminal U16 are connected to a first node 3330 between the twelfth resistor R12 and the first capacitor C1. The output terminal U13 is connected to one terminal of the thirteenth resistor R13. The reset terminal U14 and the power terminal U18 are connected to the second source S2. The control terminal U15 is grounded via the second capacitor C2. The discharge terminal U17 is connected to a second node 3332 between the eleventh resistor R11 and the twelfth resistor R12.

The alarm module 40 is connected to the signal generating circuit 333, and gives an alarm when it receives a control signal. The alarm module 40 includes a triode T1, a buzzer 402, an LED light 404, a fourteenth resistor R14, and a fifteenth resistor R15. The triode T1 includes a base B, a collector C, and an emitter E. The base B is connected to the output terminal U13 via the thirteenth resistor R13. The emitter E is grounded. The buzzer 402 and the fourteenth resistor R14 are serially connected between the collector C and the power source V_{cc}. The fifteenth resistor R15 and the LED light 404 are serially connected between the collector C and the power source V_{cc}.

The display module 50 is positioned on an outer surface of the main body 10, and is electrically connected to the angle detecting module 30. The display module 50 is configured for displaying the value of the bending angle of the support plate 20 as it is being obtained.

In operation, the support plate 20 is bent by the weight of the blade servers 200. The angle sensor 31 positioned at the support plate 20 detects the bending angle of the support plate 20 and outputs an angle signal corresponding to the bending angle. The display module 50 receives the angle signal and displays the value of the bending angle in real time. The first positive input terminal A11 and the second positive input terminal A21 of the signal amplifying module 32 receive the angle signal, and the amplified angle signal is output from the third output terminal A33. The comparator A4 compares the value of the amplified angle signal with that of the reference voltage V_{ref}. If and when the value of the amplified angle signal is greater than that of the reference voltage V_{ref}, the comparator A4 outputs a high level signal, such as +5v, from the fourth output terminal A43; otherwise, the output of the comparator A4 is a low level signal, such as 0v. When the first gate D1 of the first transistor Q1 receives a high level signal, the first transistor Q1 is switched on and the first drain D1 is grounded. The second gate G2 is grounded, and the second transistor Q2 is switched on. The 555 trigger U1 is connected to the power source V_{cc}. The first capacitor C1 is charged by the power source V_{cc} via the eleventh resistor R11 and the twelfth resistor R12. When the voltage of the first capacitor C1 is greater than ⅔ of the power source V_{cc}, the output terminal U13 outputs a high level signal. The first capacitor C1 and the discharge terminal U17 form a discharge circuit for discharging the electrical energy of the first capacitor C1. When the voltage of the first capacitor C1 is lower than ⅓ of the power source V_{cc}, the output terminal U13 outputs a low level signal. When the voltage of the first capacitor C1 is lower than ⅓ of the power source V_{cc}, the first capacitor C1 is charged; when the voltage of the first capacitor C1 is greater than ⅔ of the power source V_{cc}, the first capacitor C1 is discharged. Therefore, the 555 trigger U1 outputs a control signal with a pulse wave to the base of the triode T1. The triode T1 is switched on and switched off in quick succession. The buzzer 402 and the LED light 404 are each activated to output an alarm.

Particular embodiments are shown and described by way of illustration only. The principles and the features of the present disclosure may be employed in various and numerous embodiments thereof without separating from the scope of the disclosure. The above-described embodiments illustrate the scope of the disclosure but do not restrict the scope of the disclosure.

What is claimed is:

1. A server container, comprising:
a main body comprising two opposite sidewalls;
at least one support plate, two opposite edges of each support plate being attached to the two sidewalls;
at least one angle detecting module, each angle detecting module comprising:
an angle sensor correspondingly installed to one support plate and configured for detecting a bending angle of the support plate and generating an angle signal corresponding to the bending angle; and
a controlling module configured for comparing the voltage of the angle signal with a reference voltage which corresponds to a predetermined degree and generating a control signal upon a condition that the voltage of the angle signal is greater than the reference voltage; and
an alarm module configured for generating an alarm upon a condition of receiving the control signal.

2. The server container of claim 1, wherein each angle detecting module further comprises a signal amplifying module interconnected the angle sensor and the controlling module, the signal amplifying module is configured for amplifying the angle signal.

3. The server container of claim 2, wherein the controlling module comprises a reference voltage circuit, a signal generating circuit, and a comparing circuit interconnected the reference voltage circuit and the signal generating circuit; the reference voltage circuit is configured for supplying the reference voltage; the comparing circuit is configured for comparing the amplified angle signal with the reference voltage; the signal generating circuit is configured for outputting the control signal to the alarm module.

4. The server container of claim 3, wherein the signal amplifying module comprises a first amplifier, a second amplifier, a third amplifier, a sliding rheostat, and first, second, third, fourth, fifth, and sixth resistors; the first amplifier comprises a first positive input terminal, a first negative input terminal, and a first output terminal; the second amplifier comprises a second positive input terminal, a second negative input terminal, and a second output terminal; the third amplifier comprises a third positive input terminal, a third negative input terminal, and a third output terminal; the first positive input terminal is connected to a first terminal of the angle sensor; the second positive input terminal is connected to a second terminal of the angle sensor; the sliding rheostat is connected between the first negative input terminal and the second negative input terminal; the first resistor is connected between the first negative input terminal and the first output terminal; the second resistor is connected between the first output terminal and the third negative input terminal; one terminal of the third resistor is connected to the third negative terminal, and the other terminal of the third resistor is grounded; the fourth resistor is connected between the second output terminal and the second negative input terminal; the fifth resistor is connected between the second output terminal and the third positive input terminal; the sixth resistor is connected between the third positive input terminal and the third output terminal.

5. The server container of claim 4, wherein the reference module comprises a seventh resistor and an eighth resistor; the seventh resistor is connected between one terminal of the eighth resistor and a power source; the other terminal of the eighth resistor is grounded; a reference voltage terminal is connected between the seventh resistor and the eighth; the reference voltage is output from the reference voltage terminal

6. The server container of claim 5, wherein the comparing circuit comprises a comparator; the comparator comprises a fourth positive input terminal, a fourth negative input terminal, and a fourth output terminal; the fourth positive input terminal is connected to the third output terminal, the fourth negative input terminal is connected to the reference voltage terminal.

7. The server container of claim 6, wherein the signal generating circuit comprises a first transistor, a second transistor, a ninth resistor, and a tenth resistor; the first transistor is an N-channel MOSFET, and comprises a first source, a first gate, and a first drain; the first gate is connected to the third output terminal, the first source is grounded, the first drain is connected to the power source via the ninth resistor; the second transistor is a P-channel MOSFET, and comprises a second source, a second gate, and a second drain; the second gate is connected to the first drain, the second drain is connected to the power source via the tenth resistor, the second source is connected to the alarm module.

8. The server container of claim 7, wherein the signal generating circuit further comprises a 555 trigger, an eleventh resistor, a twelfth resistor, a thirteenth resistor, a first capacitor, and a second capacitor; the eleventh resistor and the twelfth resistor are serially connected between the second source and one terminal of the first capacitor, and the other terminal of the first capacitor is grounded; the 555 trigger comprises a ground terminal, a trigger terminal, an output terminal, a reset terminal, a control terminal, a critical terminal, a discharge terminal, and a power terminal; the ground terminal is grounded, the trigger terminal is connected to the critical terminal, the trigger terminal and the critical terminal are connected to a first node between the twelfth resistor and the first capacitor, the output terminal is connected to the thirteenth resistor, the reset terminal and the power terminal are connected to the second source, the control terminal is grounded via the second capacitor, the discharge terminal is connected to a second node between the eleventh resistor and the twelfth resistor.

9. The server container of claim 8, wherein the alarm module comprises a triode, a buzzer, an LED light, a fourteenth resistor, and a fifteenth resistor; the triode comprises a base, a collector, and an emitter; the base is connected to the output terminal of the 555 trigger via the thirteenth resistor; the emitter is grounded; the buzzer and the fourteenth resistor are serially connected between the collector and the power source; the fifteenth resistor and the LED light are serially connected between the collector and the power source.

10. The server container of claim 1, further comprising a display module, wherein the display module is connected to the angle sensor and configured for displaying the value of the bending angle.
